(19) United States
(12) Patent Application Publication
(10) Pub. No.: US 2014/0065477 A1
(43) Pub. Date: Mar. 6, 2014

(54) POSITIVE ACTIVE MATERIAL COMPOSITION FOR RECHARGEABLE LITHIUM BATTERY, AND POSITIVE ELECTRODE AND RECHARGEABLE LITHIUM BATTERY INCLUDING SAME

(71) Applicant: SAMSUNG SDI CO., LTD., Suwon-si (KR)

(72) Inventors: Seung-Hun HAN, Yongin-si (KR); Myung-Duk LIM, Yongin-si (KR); Chae-Woong CHO, Yongin-si (KR)

(73) Assignee: Samsung SDI Co., Ltd., Suwon-si (KR)

(21) Appl. No.: 13/762,831

(22) Filed: Feb. 8, 2013

(30) Foreign Application Priority Data
Sep. 6, 2012 (KR) 10-2012-0098880

(51) Int. Cl. H01M 4/525; H01M 4/505; H01M 4/131

(52) U.S. Cl. CPC H01M 4/525; H01M 4/131; H01M 4/505
USPC 429/211; 252/182.1; 252/500; 252/502

(57) ABSTRACT

A positive active material composition for a rechargeable lithium battery includes a positive active material including a first active material having a pH of about 5.00 to about 10.99 and a second active material having a pH of about 11.00 to about 13.00, an aqueous binder, and water.

### CROSS-REFERENCE TO RELATED APPLICATION

The present application claims priority under 35 U.S.C. §119 to Korean Patent Application No. 10-2012-0098880, filed on Sep. 6, 2012, in the Korean Intellectual Property Office, and entitled: “Positive Active Material Composition For Rechargeable Lithium Battery and Positive Electrode and Rechargeable Lithium Battery Including Same,” which is incorporated by reference herein in its entirety.

### BACKGROUND

1. Field

This disclosure relates to positive active material composition for a rechargeable lithium battery, and a positive electrode and a rechargeable lithium battery fabricated using the same.

2. Description of the Related Art

Rechargeable lithium batteries have recently drawn attention as a power source for small portable electronic devices. Rechargeable lithium batteries may use an organic electrolyte and thereby may a discharge voltage that is two or more times greater that of a conventional battery using an alkali aqueous solution. Accordingly, rechargeable lithium batteries may have high energy density.

The rechargeable lithium battery is manufactured by injecting an electrolyte into an electrode assembly. The electrode assembly may include a positive electrode including a positive active material capable of intercalating/deintercalating lithium ions and a negative electrode including a negative active material capable of intercalating/deintercalating lithium ions.

### SUMMARY

Embodiments are directed to a positive active material composition for a rechargeable lithium battery, the positive active material composition including a positive active material including a first active material having a pH of about 5.00 to about 10.99 and a second active material having a pH of about 11.00 to about 13.00, an aqueous binder, and water.

The first active material may include at least one selected from lithium manganese oxide and a lithium iron phosphate compound.

The second active material may include at least one selected from lithium cobalt oxide and a nickel-based oxide.

The positive active material may include about 5 wt % to about 30 wt % of the first active material and about 70 wt % to about 95 wt % of the second active material.

The positive active material may include about 10 wt % to about 20 wt % of the first active material and about 80 wt % to about 90 wt % of the second active material.

The aqueous binder may include at least one selected from carboxylmethylcellulose, hydroxyethylcellulose, hydroxypropylcellulose, hydroxypropylmethylcellulose, polyvinylidene fluoride, polytetrafluoroethylene, polyethylene, polypropylene, polybutadiene, a butyl rubber, a fluorine rubber, polyethyleneoxide, polyvinylalcohol, polyacrylic acid and a salt thereof, polyvinylpyrrolidone, polyepichlorohydrine, polyphosphazene, polyacrylonitrile, polystyrene, polyvinylpyridine, chlorosulfonated polyethylene, latex, a polyester resin, an acrylic resin, a phenolic resin, an epoxy resin, a polymer of propylene and a C2 to C8 olefin, a copolymer of (meth)acrylic acid and a (meth)acrylic acid alkylester, a copolymer of vinylidene fluoride and hexafluoropropylene, acryl-based copolymerization emulsion, and polymethylmethacrylate.

The positive active material composition may include about 70 wt % to about 98 wt % of the positive active material, about 0.2 wt % to about 10 wt % of the aqueous binder, and a balance of water.

The positive active material composition may further include a conductive material.

The conductive material may include at least one selected from natural graphite, artificial graphite, carbon black, acetylene black, ketjen black, a carbon fiber, carbon nanotube, a metal powder, a metal fiber, and a conductive polymer.

The positive active material composition may have a pH of 7 to 10.99.

Embodiments are also directed to a positive electrode for a rechargeable lithium battery, the positive electrode including a metal current collector; and a positive active material layer formed using the positive active material composition, as described above, disposed on the metal current collector.

The metal current collector may include aluminum.

Embodiments are also directed to a rechargeable lithium battery including the positive electrode as described above, a negative electrode, and an electrolyte.

### BRIEF DESCRIPTION OF THE DRAWING

Features will become apparent to those of ordinary skill in the art by describing in detail exemplary embodiments with reference to the attached drawings in which:

FIG. 1 illustrates a schematic view showing the lithium rechargeable battery according to one embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

According to one embodiment, a positive active material composition for a rechargeable lithium battery may include at least two kinds of positive active materials, an aqueous binder, and water. The positive active material composition may include water as a solvent and thus, may be aqueous.

The positive active material includes a first active material having a pH of about 5.00 to about 10.99 and a second active material having a pH of about 11.00 to about 13.00.

A metal current collector may include aluminum components having a thin Al₂O₃ oxidation layer on the surface. The oxidation layer may hinder aluminum from reacting with water in a neutral aqueous solution. Thus, the occurrence of a reaction of generating hydrogen gas according to the following reaction scheme 1 may be reduced or prevented.

2Al+3H₂O→Al₂O₃+3H₂↑ [Reaction Scheme 1]

However, if the oxidation layer were to have a reaction represented by the following reaction scheme 2 in an alkali aqueous solution, aluminate ions could be eluted into the surrounding solution and a reaction represented by the following reaction scheme 3 could occur on the surface of an aluminum current collector. Thereby, hydrogen gas could be generated and pin holes could be formed in the surface of an electrode.

Al₂O₃+H₂O+2OH−→2AlO₂−+2H₂O [Reaction Scheme 2]

2Al+6OH−+6H₂O→2[Al(OH)₆]³⁻+3H₂↑ [Reaction Scheme 3]

According to one embodiment, corrosion of a metal current collector such as aluminum may be reduced or prevented and thus, a capacity deterioration may be minimized. In an embodiment, an aqueous positive active material composition is prepared by mixing an active material having low pH and another active material having high pH.

The first active material having low pH may be at least one selected from lithium manganese oxide and a lithium iron phosphate compound. The lithium manganese oxide may be represented by Formulas 1 or 2; and The lithium iron phosphate compound may be represented by Formulas 3 or 4.

LiₐMn_{1-b}R_{b}O₂ [Formula 1]

LiₐMn_{2-b}R_{b}O_{4-c}D_{c} [Formula 2]

wherein, 0.90≦a≦1.8, 0≦b≦0.5, 0≦c≦0.05,

R is Al, Ni, Co, Mn, Cr, Fe, Mg, Sr, V, a rare earth element or a combination thereof.

Li_{(3-f)}Fe₂(PO₄)₃(0≦f≦2) [Formula 3]

LiₐFePO₄. [Formula 4]

wherein, 0.90≦a≦1.8

The second active material having high pH may be at least one selected from lithium cobalt oxide and nickel-based oxide. The nickel-based oxide may be at least one selected from lithium nickel cobalt manganese oxide and lithium nickel cobalt aluminum oxide. The lithium cobalt oxide may be represented by Formula 5, the lithium nickel cobalt manganese oxide may be represented by Formula 6, and the lithium nickel cobalt aluminum oxide may be represented by Formula 7.

LiₐCo_{1-b}R_{b}O₂ [Formula 5]

wherein, 0.90≦a≦1.8, 0≦b≦0.5, 0≦c≦0.05

LiₐNi_{1-b-c-e}Co_{b}Mn_{c}GₑO₂ [Formula 5]

wherein, 0.90≦a≦1.8, 0≦b≦0.5, 0≦c≦0.05, 0.001≦e≦0.1

G is Al, Cr, Mn, Fe, Mg, La, Ce, Sr, V or a combination thereof.

LiₐNi_{1-b-c-e}CO_{b}Al_{c}GₑO₂ [Formula 5]

wherein, 0.90≦a≦1.8, 0≦b≦0.5, 0≦c≦0.05, 0.001≦e≦0.1

The positive active material may include about 5 wt % to about 30 wt % of the first active material and about 70 wt % to about 95 wt % of the second active material, for example, about 10 wt % to about 20 wt % of the first active material and about 80 wt % to about 90 wt % of the second active material. When the first and second active materials are mixed within the ratio range, corrosion of a metal current collector may be reduced or prevented, capacity deterioration may be minimized, and higher capacity may be obtained.

The positive active material may be included in the positive active material composition in an amount ranging from about 50 wt % to about 80 wt % based on the total amount of the positive active material composition. When the positive active material is included within the range, corrosion of the metal current collector and a deterioration of capacity may be reduced or prevented.

An aqueous binder is compatible with a moisture atmosphere and thus, does not require a dry room or a recycling process. Accordingly, an aqueous binder is environmentally-friendly and mass production equipment for handling the aqueous binder may be less than that used for a non-aqueous binder. In addition, the aqueous binder has a binding mechanism that does not rely on the specific surface area of an electrode material. Thus, the aqueous binder may be applied to materials having a large specific surface area. Also, the aqueous binder may have low reactivity with an electrolyte and thus, may have excellent stability with respect to heat generation.

The aqueous binder may include at least one selected from carboxylmethylcellulose, hydroxyethylcellulose, hydroxypropylcellulose, hydroxypropylmethylcellulose, polyvinylidene fluoride, polytetrafluoroethylene, polyethylene, polypropylene, polybutadiene, a butyl rubber, a fluorine rubber, polyethyleneoxide, polyvinylalcohol, polyacrylic acid and a salt thereof, polyvinylpyrrolidone, polyepichlorohydrine, polyphosphazene, polyacrylonitrile, polystyrene, polyvinylpyridine, chlorosulfonated polyethylene, latex, a polyester resin, an acrylic resin, a phenolic resin, an epoxy resin, a polymer of propylene and a C2 to C8 olefin, a copolymer of (meth)acrylic acid and a (meth)acrylic acid alkylester, a copolymer of vinylidene fluoride and hexafluoropropylene, acryl-based copolymerization emulsion, and polymethylmethacrylate.

The aqueous binder may be included in an amount ranging from about 0.2 wt % to about 10 wt %, for example, 1 wt % to 5 wt % based on the total amount of the positive active material composition. When the aqueous binder is included within the range, the aqueous binder may bind dispersed positive active material particles and may bind the positive active material particles with a current collector. Thus, corrosion of the metal current collector and capacity deterioration may be reduced or prevented.

As for the positive active material composition, water may be used as a solvent. According to one embodiment, a rechargeable lithium battery fabricated by using the positive active material composition prepared by using water, which is non-toxic, instead of an organic solvent that may be toxic, such as, for example, N-methylpyrrolidone and the like, may reduce or prevent harm to humans and may decrease fabrication costs.

The water may be included in a balance amount, for example, in an amount of about 15 wt % to about 50 wt % based on the total amount of the positive active material composition.

The positive active material composition may further include a conductive material. The conductive material may include at least one selected from natural graphite, artificial graphite, carbon black, acetylene black, ketjen black, a carbon fiber, carbon nanotubes, a metal powder, a metal fiber, and a conductive polymer.

The conductive material may be included in an amount of about 0.5 wt % to about 5 wt %, for example, about 2 wt % to about 5 wt % based on the total amount of the positive active material composition.

The positive active material composition may have pH ranging from about 7 to about 10.99 and specifically, about 9 to about 10.99.

The positive active material composition may reduce or prevent corrosion of the metal current collector and thus, may reduce or prevent an increase in internal resistance. Accordingly, a high rate capability and cycle-life characteristic of a rechargeable lithium battery may be improved.

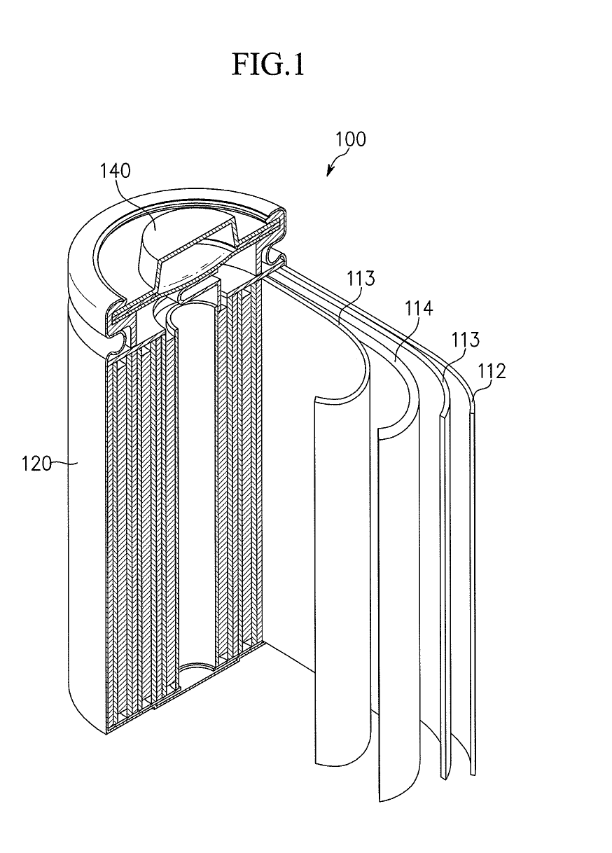

Hereinafter, a rechargeable lithium battery fabricated by using the positive active material composition is illustrated referring to FIG. 1.

FIG. 1 illustrates a schematic view showing the lithium rechargeable battery according to one embodiment. Referring to FIG. 1, a rechargeable lithium battery 100 according to one embodiment includes a positive electrode 114, a negative electrode 112 facing the positive electrode 114, a separator 113 interposed between the negative electrode 112 and the positive electrode 114, an electrolyte (not shown) impregnating the separator 113, a battery case 120, and a sealing member 140 sealing the battery case 120.

The positive electrode 114 includes a metal current collector, and a positive active material layer formed by using the positive active material composition disposed on the metal current collector. The positive active material composition may be the same as described above. The metal current collector may include aluminum, as an example. The positive electrode 114 may be manufactured by applying the positive active material composition on the metal current collector.

The negative electrode 112 includes a negative current collector and a negative active material layer disposed on the negative current collector. The negative current collector may be a copper foil.

The negative active material layer may include a negative active material, a binder, and optionally, a conductive material.

The negative active material may include a material that reversibly intercalates/deintercalates lithium ions, lithium metal, a lithium metal alloy, a material being capable of doping/dedoping lithium, transition metal oxide, or a combination thereof.

The material that reversibly intercalates/deintercalates lithium ions may be a carbon material. The carbon material may be any suitable carbon-based negative active material in a lithium ion rechargeable battery. Examples of the carbon material include crystalline carbon, amorphous carbon, and mixtures thereof. The crystalline carbon may be shapeless, or sheet, flake, spherical, or fiber shaped natural graphite or artificial graphite. The amorphous carbon may be a soft carbon, a hard carbon, a mesophase pitch carbonized product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

Examples of the material being capable of doping/dedoping lithium include a Si-based compound such as Si, SiOₓ (0<x<2), a Si—C composite, a Si-Q alloy (wherein Q is an alkali metal, an alkaline-earth metal, a Group 13 to 16 element, a transition element, a rare earth element, or a combination thereof, and not Si), a Si—C composite, or a combination thereof; a Sn-based compound such as Sn, SnO₂, a Sn—C composite, a Sn—R alloy (wherein R is an alkali metal, an alkaline-earth metal, a Group 13 to 16 element, a transition element, a rare earth element, or a combination thereof, and not Sn), or a combination thereof; or a combination of a Si-based compound and a Sn-based compound. At least one of these materials may be mixed with SiO₂. The elements Q and R may be selected from, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, and the like.

The binder improves binding properties of negative active material particles with one another and with a current collector. The binder includes a non-water-soluble binder, a water-soluble binder, or a combination thereof.

The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The alkali metal may be Na, K, or Li. The cellulose-based compound may be included in an amount of about 0.1 to about 3 parts by weight based on 100 parts by weight of the negative active material.

The conductive material may be included to improve electrode conductivity. Any electrically conductive material that does not cause a chemical change may be used as a conductive material. Examples of the conductive material include a carbon-based material such as natural graphite, artificial graphite, carbon black, acetylene black, ketjen black, a carbon fiber, and the like; a metal-based material of metal powder or metal fiber including copper, nickel, aluminum, silver, and the like; a conductive polymer such as polyphenylene derivatives; or a mixture thereof.

The negative electrode 112 may be manufactured by mixing the negative active material, the conductive material, and the binder to prepare a negative active material composition and coating the negative active material composition on a negative current collector, respectively. The solvent may include N-methylpyrrolidone and the like, as an example.

The electrolyte solution may include a non-aqueous organic solvent and a lithium salt.

The non-aqueous organic solvent may serve as a medium for transmitting ions taking part in the electrochemical reaction of a battery. The non-aqueous organic solvent may be selected from a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like.

When the linear carbonate compounds and cyclic carbonate compounds are mixed, an organic solvent having high dielectric constant and low viscosity can be provided. The cyclic carbonate and the linear carbonate may be mixed together in a volume ratio ranging from about 1:1 to about 1:9.

Examples of the ester-based solvent may include n-methylacetate, n-ethylacetate, n-propylacetate, dimethylacetate, methylpropionate, ethylpropionate, γ-butyrolactone, decanolide, valerolactone, mevalonolactone, caprolactone, or the like. Examples of the ether-based solvent include dibutyl ether, tetraglyme, diglyme, dimethoxyethane, 2-methyltetrahydrofuran, tetrahydrofuran, or the like. Examples of the ketone-based solvent include cyclohexanone, or the like. Examples of the alcohol-based solvent include ethyl alcohol, isopropyl alcohol, or the like.

The non-aqueous organic solvent may be used singularly or in a mixture. When the organic solvent is used in a mixture, the mixture ratio can be controlled in accordance with a desirable battery performance.

The non-aqueous electrolyte may further include an overcharge inhibiting additive such as ethylenecarbonate, pyrocarbonate, or the like.

The lithium salt is dissolved in an organic solvent, supplies lithium ions in a battery to operate the rechargeable lithium battery, and improves lithium ion transportation between positive and negative electrodes therein.

The lithium salt may include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, LiB(C₂O₄)₂ (lithium bis(oxalato) borate, LiBOB), or a combination thereof, as a supporting electrolytic salt.

The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

The separator 113 may include any suitable material that provides separation of a negative electrode 112 from a positive electrode 114 and provides a transporting passage for lithium ions. The separator 113 may be made of a material having a low resistance to ion transportation and an excellent impregnation of an electrolyte. For example, the material for the separator 113 may be selected from glass fiber, polyester, TEFLON (tetrafluoroethylene), polyethylene, polypropylene, polytetrafluoroethylene (PTFE), or a combination thereof. The material for the separator 113 may have a form of a non-woven fabric or a woven fabric. For example, a polyolefin-based polymer separator such as polyethylene-based, polypropylene-based or the like may be used. In order to ensure suitable heat resistance or mechanical strength, a coated separator including a ceramic component or a polymer material may be used. Selectively, the separator 113 may have a mono-layered or multi-layered structure.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### EXAMPLE 1

86.4 g of a LiCoO₂ powder having pH of 11.25, 9.6 g of LiMn₂O₄ having pH of 10.3, 2 g of acetylene black, 1 g of carboxylmethylcellulose, and 90 g of water were mixed. Next, 150 g of water and 2.5 g of an acryl-based copolymerization emulsion solid (AX-4069, Nippon Zeon Co.) were added to the mixture to prepare a positive active material composition. The positive active material composition was coated to be 150 μm thick on a 15 μm-thick aluminum current collector using a bar coater and dried in a 110° C. oven for 10 minutes, fabricating a positive electrode.

A negative electrode was fabricated by primarily mixing 97.5 g of graphite (MAG-V4), 1 g of carboxylmethylcellulose, and 50 g of water, adding 1.5 g of a styrene-butadiene rubber binder (40% of a solid) (BM400B, Nippon Zeon Co.) and 50 g of water thereto to prepare slurry, coating the slurry on a copper current collector, and drying the coated slurry.

The positive and negative electrodes were used with a polyethylene/polypropylene separator and an electrolyte solution prepared by mixing ethylenecarbonate (EC):diethylcarbonate (DEC):dimethylcarbonate (DMC) in a volume ratio of 1:1:8 and dissolving 1.3 M of LiPF₆ therein, fabricating a CR-2032 coin cell having a diameter of 20 mm.

### EXAMPLE 2

A coin-cell was fabricated according to the same method as Example 1 except for using 76.8 g of the LiCoO₂ powder and 19.2 g of LiMn₂O₄ to prepare a positive active material composition.

### EXAMPLE 3

A half-cell was fabricated according to the same method as Example 1 except for using 67.2 g of the LiCoO₂ powder and 28.8 g of LiMn₂O₄ to prepare a positive active material composition.

### COMPARATIVE EXAMPLE 1

96 g of LiCoO₂ powder having pH of 11.25, 2 g of acetylene black, 1 g of carboxylmethylcellulose, and 90 g of water were mixed. Next, 210 g of water and 2.5 g of an acryl-based copolymerization emulsion solid (AX-4069, Nippon Zeon Co.) were added to the mixture, preparing a positive active material composition. The positive active material composition was coated to be 150 μm thick on a 15 μm-thick aluminum current collector using a bar coater and dried in a 110° C. oven for 10 minutes, fabricating a positive electrode.

A negative electrode was fabricated by primarily mixing 97.5 g of graphite (MAG-V4), 1 g of carboxylmethylcellulose, and 50 g of water, adding 1.5 g of a binder (BM400B, Nippon Zeon Co.) (40% of a solid) and 50 g of water thereto to prepare slurry, coating the slurry on a copper film, and drying the slurry.

The positive and negative electrodes were used with a polyethylene/polypropylene separator and an electrolyte solution prepared by mixing ethylenecarbonate (EC):diethylcarbonate (DEC):dimethylcarbonate (DMC) in a volume ratio of 1:1:8 and dissolving 1.3 M of LiPF₆ therein, fabricating CR-2032 coin cell having a diameter of 20 mm.

Evaluation 1: pH Measurement of Positive Active Material Composition

The positive active material compositions according to Examples 1 to 3 and Comparative Example 1 were allowed to stand for 5 days and daily measurements of pH were taken. The results are provided in the following Table 1.

TABLE 1

| | pH of positive active material composition | | | | | |
|---|---|---|---|---|---|---|
| | 0 day | 1 day | 2 day | 3 day | 4 day | 5 day |
| Example 1 | 10.9 | 10.92 | 10.93 | 10.95 | 10.95 | 10.95 |
| Example 2 | 10.82 | 10.84 | 10.85 | 10.85 | 10.85 | 10.85 |
| Example 3 | 10.61 | 10.66 | 10.66 | 10.66 | 10.66 | 10.66 |
| Comparative | 11.12 | 11.15 | 11.16 | 11.16 | 11.16 | 11.16 |
| Example 1 | | | | | | |

Referring to Table 1, the aqueous positive active material compositions prepared by mixing an active material having low pH and another active material having high pH according to Examples 1 to 3 had pH ranging from about 10.61 to about 10.95.

Evaluation 2: Cycle-Life Characteristic of Rechargeable Lithium Battery

The rechargeable lithium battery cells according to Examples 1 to 3 and Comparative Example 1 were measured regarding cycle-life characteristic. The results are provided in the following Table 2.

The charge and discharge formation of the rechargeable lithium battery cells was performed with current density of 0.05 C at a cut-off voltage of 4.2V during the charge and a cut-off voltage of 3.0V during the discharge.

Then, the rechargeable lithium battery cells were charged with current density of 0.8 C and an ending voltage of 4.2V during the charge and discharged with 3.0V and current density of 1.0 C. The cycle was 100 times repeated.

In the following Table 2, the capacity retention (%) of the rechargeable lithium battery cells was calculated as a percentage of discharge capacity at the 100th cycle related to discharge capacity at the 1st cycle.

TABLE 2

| | | 1st cycle | 100th cycle | |
|---|---|---|---|---|
| | Designed | discharge | discharge | Capacity |
| | capacity | capacity | capacity | retention (%) |
| Example 1 | 140.5 | 139.1 | 130.8 | 94.0 |
| Example 2 | 136.0 | 134.5 | 125.7 | 93.5 |
| Example 3 | 131.5 | 130.3 | 122.6 | 94.1 |
| Comparative | 145.0 | 125.2 | 97.7 | 78.0 |
| Example 1 | | | | |

Referring to Table 2, the aqueous positive active material compositions prepared by mixing an active material having low pH and another active material having high pH according to Examples 1 to 3 realized better cycle-life characteristic of a rechargeable lithium battery than the one including an active material having high pH according to Comparative Example 1. Accordingly, it can be reasonably concluded that the positive active material compositions prevented corrosion of a metal current collector and did not increase internal resistance of the rechargeable lithium battery.

By way of summation and review, when a positive active material is used with an aqueous binder to fabricate an electrode, unreacted lithium ions of the positive active material or lithium ions dissociated therefrom in water may provide a strong basicity, for example, greater than or equal to about pH 11, to an aqueous positive active material composition.

Accordingly, when the aqueous positive active material composition having strong basicity is coated on an aluminum current collector to produce an electrode, the aluminum current collector may be corroded due to the high pH and may generate H₂ gas. Numerous pinholes may be formed on the electrode and the internal resistance of the electrode may be increased.

If a conductive material layer were to be coated onto an aluminum current collector in an effort to prevent the current collector from contacting with aqueous positive active material slurry and to provide an anti-corrosion effect to the current collector, the capacity of the rechargeable lithium battery formed therewith may be deteriorated due the volume increase provided by the conductive material layer.

In contrast, embodiments provide a positive active material composition for a rechargeable lithium battery that may reduce or prevent corrosion of a metal current collector and may provide a high rate capability and excellent cycle-life characteristic.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope as set forth in the following claims.

1. A positive active material composition for a rechargeable lithium battery, the positive active material composition comprising:
a positive active material including a first active material having a pH of about 5.00 to about 10.99 and a second active material having a pH of about 11.00 to about 13.00, the first active material and the second active material being mixed together in the positive active material;
an aqueous binder; and
water.

2. The positive active material composition for a rechargeable lithium battery as claimed in claim 1, wherein the first active material includes at least one selected from lithium manganese oxide and a lithium iron phosphate compound.

3. The positive active material composition for a rechargeable lithium battery as claimed in claim 1, wherein the second active material includes at least one selected from lithium cobalt oxide and a nickel-based oxide.

4. The positive active material composition for a rechargeable lithium battery as claimed in claim 1, wherein the positive active material includes about 5 wt % to about 30 wt % of the first active material and about 70 wt % to about 95 wt % of the second active material.

5. The positive active material composition for a rechargeable lithium battery as claimed in claim 1, wherein the positive active material includes about 10 wt % to about 20 wt % of the first active material and about 80 wt % to about 90 wt % of the second active material.

6. The positive active material composition for a rechargeable lithium battery as claimed in claim 1, wherein the aqueous binder includes at least one selected from carboxylmethylcellulose, hydroxyethylcellulose, hydroxypropylcellulose, hydroxypropylmethylcellulose, polyvinylidene fluoride, polytetrafluoroethylene, polyethylene, polypropylene, polybutadiene, a butyl rubber, a fluorine rubber, polyethyleneoxide, polyvinylalcohol, polyacrylic acid and a salt thereof, polyvinylpyrrolidone, polyepichlorohydrine, polyphosphazene, polyacrylonitrile, polystyrene, polyvinylpyridine, chlorosulfonated polyethylene, latex, a polyester resin, an acrylic resin, a phenolic resin, an epoxy resin, a polymer of propylene and a C2 to C8 olefin, a copolymer of (meth)acrylic acid and a (meth)acrylic acid alkylester, a copolymer of vinylidene fluoride and hexafluoropropylene, acryl-based copolymerization emulsion, and polymethylmethacrylate.

7. The positive active material composition for a rechargeable lithium battery as claimed in claim 1, wherein the positive active material composition includes:
about 50 wt % to about 80 wt % of the positive active material;
about 0.2 wt % to about 10 wt % of the aqueous binder; and
a balance of water.

8. The positive active material composition for a rechargeable lithium battery as claimed in claim 1, wherein the positive active material composition further includes a conductive material.

9. The positive active material composition for a rechargeable lithium battery as claimed in claim 8, wherein the conductive material includes at least one selected from natural graphite, artificial graphite, carbon black, acetylene black, ketjen black, a carbon fiber, carbon nanotube, a metal powder, a metal fiber, and a conductive polymer.

10. The positive active material composition for a rechargeable lithium battery as claimed in claim 1, wherein the positive active material composition has a pH of 7 to 10.99.

11. A positive electrode for a rechargeable lithium battery, the positive electrode comprising:
a metal current collector; and
a positive active material layer disposed on the metal current collector, wherein the positive active material layer formed by using the positive active material composition according to claim 1.

12. The positive electrode for a rechargeable lithium battery as claimed in claim 11, wherein the metal current collector includes aluminum.

13. A rechargeable lithium battery, comprising
the positive electrode as claimed in claim 11;
a negative electrode; and
an electrolyte.
